(19) United States
(12) Patent Application Publication
(10) Pub. No.: US 2003/0220810 A1
(43) Pub. Date: Nov. 27, 2003

(54) Registry for management of intellectual property rights, properties and constraints

(75) Inventor: Thomas Probert, Holden, MA (US)

Correspondence Address: FOLEY HOAG, LLP, PATENT GROUP, WORLD TRADE CENTER WEST, 155 SEAPORT BLVD, BOSTON, MA, 02110, US

(73) Assignee: Thomas Probert, Holden, MA

(21) Appl. No.: 10/374,255

(22) Filed: Feb. 26, 2003

Related U.S. Application Data
(63) Continuation of application No. PCT/US01/26779, filed on Aug. 28, 2001.
(60) Provisional application No. 60/228,428, filed on Aug. 28, 2000.

(51) Int. Cl. G06F 17/60

(52) U.S. Cl. 705/1; 705/26

(57) ABSTRACT

An invention comprising a method and system for the identification and management on a computer network of rights, properties and constraints associated with creative works is described. One specific embodiment of the invention, relating to the online management of intellectual property rights, properties and constraints associated with learning materials which may be utilized in the development of Internet-based training, is described, but the invention is not limited to that application.

### RELATED APPLICATIONS

This application is a continuation application of PCT/US01/26779, filed on Aug. 28, 2001, naming Thomas Probert as inventor, which claims the benefit of U.S. S. No. 60/228,428, filed on Aug. 28, 2000, all of the contents of which are herein incorporated by reference in their entirety.

### FIELD OF THE INVENTION

This invention generally relates to management of intellectual property rights, properties and constraints in a computer information system or network.

### DESCRIPTION OF RELATED ART AND THE PROBLEM

The use of computer networks such as the Internet provides the ability to rapidly search, locate and accumulate materials for further combination or assembly into single products and/or collections to be further distributed. Tracking the ownership or other rights to the individual components of these products or collections may be difficult and may reduce the utility of the computer network or Internet in creating these products or collections.

One example of the use of the Internet to combine or assemble materials into a single product or collection is the assembly of works of art from the same or different media such as video clips, audio clips, graphics, animations and text. Each component in such an assembly may have different intellectual property rights associated with it as well as different properties or constraints on its use. Components need not be limited to electronic objects and may include physical objects related to the purpose of the component as envisioned by its author. For example, a textbook might be associated with a computer-based training component. It may be important that such linkages between components of different media be maintained under further aggregation.

The assembly of components into a product and/or collection may create certain rights for the creator/aggregator/assembler in addition to those rights associated with the individual components used in the product and/or collection. It may be desirable that these rights also be identified and maintained.

In addition, these assemblies may in turn be considered compound components, consisting of the contributions of large numbers of creators. These compound components may be used to create even more complex assemblies.

The use of a registry to facilitate the real-time identification of such rights, properties and constraints associated with the individual or compound components even after the aggregation into complex aggregations may greatly facilitate the use of a computer network such as the Internet in the creation and management of creative works.

### SUMMARY OF THE INVENTION

In accordance with the principles of the invention, a method and device for the identification and management on a computer network such as the Internet of rights, properties and constraints associated with creative works is described. One specific embodiment of the invention, relating to the online management of intellectual property rights, properties and constraints associated with learning materials which may be utilized in the development of Internet-based training, is described. Another specific embodiment of the invention involves associating a component number for a plurality of components, where the component number is an index to an Instructional Management System (“IMS”) learning component metadata standard record in a registry, which record comprises the component number associated with the component. Developers are permitted to create new components comprising new material and components already in the registry. For each new component created, a component number is associated with the component, where the component number is an index to an IMS learning component metadata standard record in the registry, the record comprising the component number associated with the component and pointers to registry records of components used in its creation. Distributors are permitted to purchase uses of an entry in the registry and make payment for the uses. The invention is not limited to the foregoing embodiments.

Other aspects of the invention will be shown from the following description of the systems and methods herein.

### BRIEF DESCRIPTION OF THE DRAWINGS

The above-mentioned and other features of the invention will now become apparent by reference to the following description taken in connection with the accompanying drawings, in which:

FIG. 1 illustrates an example of the structure of a “composition tree” used to identify the rights, properties and constraints associated with a creative work, in this case a training course with associated physical objects.

FIG. 2 illustrates an example of a data structure used to implement the composition tree as a linked list commonly used in computer science.

### DETAILED DESCRIPTION OF THE PREFERRED EMBODIMENT(S)

There may be considered to be a parallel between the “software crisis” of the 70's and 80's and the current demand for Internet-based training. In both situations developers may be considered to be few and in high demand, tools may be considered to be elementary and products may be considered to be specialized or “one-off/stovepipe” in structure and application. One approach to the “software crisis” was to develop object-oriented programming and software tools that exploited reusable objects. This may have enabled the development of large code repositories that further may have enabled the evolution of better tools and a rapid return on investment.

A similar approach may also be useful in the development of Internet-based training.

The invention comprises a system and method for maintaining a registry for the management of intellectual property rights, properties and constraints associated with a collection of materials. The registry may be maintained on-line on the Internet or on another computer network or computer information system. The purpose is to facilitate the combination of items in the collection into products.

One embodiment of the invention is designed to facilitate the posting and accessing of learning components to be utilized in the development of Internet-based training. Learning components are reusable bits of information ranging from pictures to consolidated subject matter that can be used to build on-line courses for training and education on the Internet.

While the invention is not limited to this embodiment, the embodiment allows normal users and businesses to make various kinds of learning content available and get paid for that content if it is used for business-to-business (“B2B”) or business-to-consumer (“B2C”) commercial gain by course developers and distributors worldwide.

The embodiment facilitates an Internet service, available to both suppliers and users of Internet-based learning and education tools, courses and infrastructure.

Standard formats exist for the materials used to construct Internet-based training. This embodiment of the invention makes possible the creation of large repositories (“registries”) of components analogous to the now-familiar libraries of software objects. (“Component” is used instead of “object” to refer to training materials intended to be aggregated into higher level constructs because an “object” in computer science consists of the functions and associated data structures upon which the functions work, while a component is merely a collection of material that might be employed in the development of a training application.)

According to the embodiment, training developers using today's application development tools to rapidly and efficiently construct training applications can access these registries. Sharing these resources decreases the development cost and time required to field new training products, creating the opportunity for training vendors to create a competitive advantage by decreasing the price of online training.

According to the embodiment, the materials needed for the efficient construction of online training include:

1. Low level or “raw” components such as elementary graphics, text segments, chemical or mathematical formulae in elementary mathematical typeface, pictures and other visuals.

2. Low level composite components made up of components from level 1 and including executables such as Java applets, composite graphics, and active buttons for frame movement.

3. Composite components with educational content such as contextual representations such as frames or modules.

4. Complex composite components including “learning objects” or simple topical assemblies approximating “lessons.”

5. Very complex composite components including whole online courses or even curricula.

According to the embodiment, each of these levels can be composed of original material and supplemented with many components from the levels below. As in the development of software components, this process of aggregation can accelerate training development.

According to the embodiment, a Web-based component repository focused on supporting the collection, classification and distribution of reusable components for online training development is utilized. The registry is a generalization of the situation in place with today's authoring tools wherein libraries of proprietary components such as button formats, visual frames, backgrounds and other pre-cut components are offered by each vendor for use with its proprietary toolset.

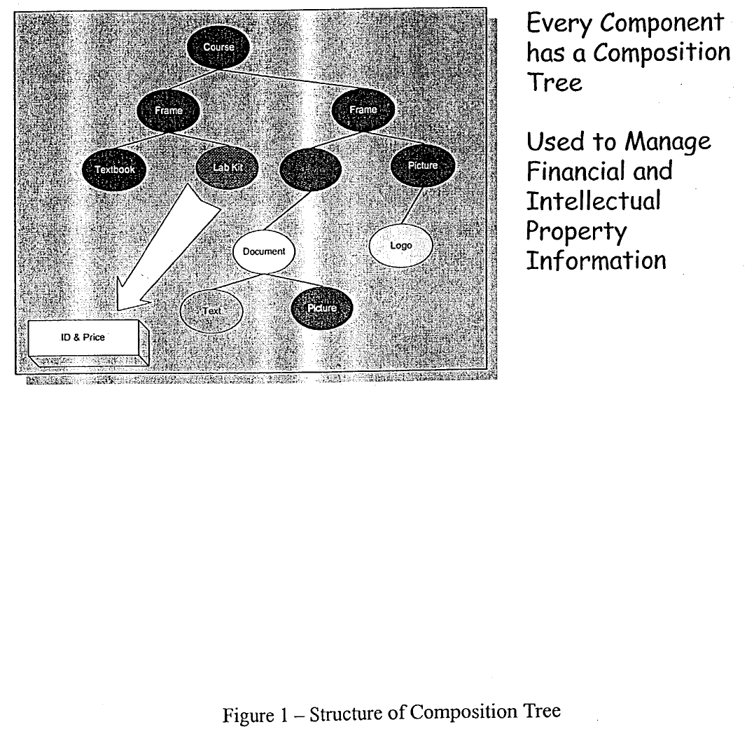

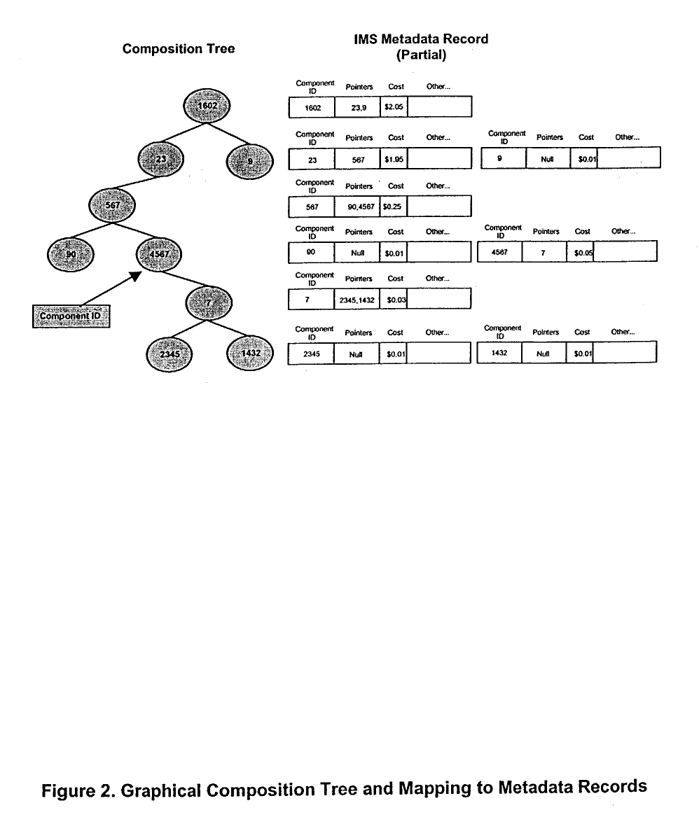

According to the embodiment, access to the registry is provided to two communities or entities, Developers and Distributors, and an entity may be both concurrently. Developers access components to enhance and/or include them in components they have under development. When appropriate, the Developer may register and upload a component to the Registry for others to access. Thus, a low-level component may be accessed, downloaded, enhanced and re-registered many times and at each stage in the cycle, the cost and intellectual property ownership of the component may be propagated as part of the new component through the management of a “composition tree” as depicted in FIGS. 1 and 2.

According to the embodiment, the underlying structure of the composition tree as shown in FIG. 2 is based on the emerging Instructional Management Systems (“IMS”) learning component metadata standard. Referring to FIG. 2, each component number in the composition tree is an index to an IMS metadata record in the registry that describes each component and its relationship to other components from which it is composed. Visibility into the leaves of the composition tree are limited to only the current working level as a complex component could have tens to hundreds of sub-components. Without this limit, manipulation of components according to the structure and details of the composition tree would be overly complicated and probably not very productive for the majority of developers.

According to the embodiment, the use of the composition tree to support Web-based aggregate development of training materials enables the distribution of tools, techniques, templates and examples as well. For instance, media tool vendors will make “lite” versions of their tools available for download to registered Developers of components for distribution in the registry. Any Developer that uses these tools, templates and examples will specify such use when they post the component into the registry. This will create a vendor specified value entry into the composition tree for that component. This creates a much broader marketplace for the tool vendor and defers the cost of tool use for the Developer.

According to the embodiment, the registry is an e-commerce repository of components open to all registered Developers prepared to participate in the development and sale of training components.

According to the embodiment, registered Developers conduct transactions with the registry as they search for, evaluate and retrieve components for inclusion into their current development effort, tracked through a transaction log by Component ID. The transaction log helps identify and correct any errors of omission made by Developers as they post their components to the registry. It also helps in locating deliberate misuse of intellectual property.

For example, should a Developer notice that another has apparently improperly used her material; she could request that the transaction logging be examined to determine if the potentially offending user had ever accessed her material.

As components are aggregated, training materials are developed, enhanced and prepared for distribution. As each is re-posted to the registry its composition tree is modified to contain an entry to all others who “contributed” to its value whether it be through tool use, component reuse or other such value added activity. Each re-posting also requires the generation of IMS metadata describing the component so that it can be located and evaluated.

According to the embodiment, the registry also provides for the registration of Distributors, anyone interested in distributing products available in the Registry. At some point a Developer determines that it has a product ready for distribution and sale. At that point the item changes status from a modifiable component to an unchangeable “product.” It is placed on a “distribution list” that is accessible by registered Distributors including anyone capable of training delivery and sale.

Distributors can customize their interest list, search for, download and evaluate training products. Should a product be selected for use by a Distributor, he or she records his or her “purchase” of an appropriate number of “uses” and remits a fee dependant upon the aggregated cost of the training product. The Distributors are then free to charge whatever they wish for the training product

Component and product usage is reported as a Product (or Component) ID, a usage and an amount and the required fee is then transferred. The registry processes this information by fracturing the payment according to the composition tree and its associated metadata records. Electronic funds transfers are made from the registry accounts to the Developer accounts as indicated by the composition tree and the Developer profile information.

According to the embodiment, revenue may be generated through a combination of:

1. e-commerce transactions. A component cost may include a registry usage fee generated each time a component is sold for commercial gain either as a standalone component, as part of component group, or as part of an on-line course.

2. Referral fees to industry vendors. The Web site may include links to e-learning applications vendors, instructional design vendors and training course vendors to create pass through referral revenue.

3. Quality certification, supply and demand community development, training course consulting, and data mining services. Revenue may be generated through a variety of value-added services.

4. Advertising of third party e-learning products and services.

One application of the invention has been described, its use in an online registry for posting and accessing learning components to be utilized in the development of Internet-based training. This has been done in order to illustrate the principles which underlie the invention. However, it will be apparent to one of ordinary skill in the art that the invention may equally be embodied in registries of other materials which are to be combined for other purposes, and that the registries may be maintained in computer information systems or computer networks as well as on-line or on the Internet.

What is claimed is:

1. A method for maintaining in a computer information system a registry for identification and management of intellectual property rights, properties and constraints associated with creative works, comprising:
a. creating a composition tree comprising entries for each component entered into the registry;
b. using an Instructional Management Systems (“IMS”) learning component metadata standard as a basis for a structure of the composition tree;
c. making each component number in the composition tree an index to an IMS metadata record in the registry describing that component and its relationship to components which were utilized to create it;
d. permitting developers of creative works access to the registry;
e. permitting developers to enter original components into the registry;
f. associating with each original component entered into the registry an original component registry entry comprising a component number for that component;
g. permitting developers to create new components comprising new material and components already in the registry;
h. for each new component created, placing into the registry a new component registry entry comprising a component number for that component and pointers to registry components which were used in its creation;
i. permitting distributors access to the registry;
j. permitting distributors to search the registry for entries of interest;
k. permitting distributors to purchase uses of an entry in the registry and make payment for the uses.

2. The method of claim 1, wherein the computer information system is a computer network.

3. The method of claim 2, wherein the computer network is the Internet.

4. The method of claim 1, wherein the creative works are learning materials.

5. The method of claim 4, wherein the learning materials are to be utilized in developing computer-network based training.

6. The method of claim 1, wherein a transaction log by component that records each use of that component is maintained.

7. The method of claim 1, wherein the original component registry entry further comprises the original component cost and ownership.

8. The method of claim 1, wherein the new component registry entry further comprises the new component cost and ownership.

9. A method for maintaining in a computer information system a registry for identification and management of intellectual property rights, properties and constraints associated with creative works, comprising:
a. for a plurality of original components, associating a component number with the component, where the component number is an index to an Instructional Management Systems (“IMS”) learning component metadata standard record in the registry, which record comprises the component number associated with the component;
b. permitting developers to create new components comprising new material and components already in the registry;
c. for each new component created, associating a component number with the component, where the component number is an index to an Instructional Management Systems (“IMS”) learning component metadata standard record in the registry, which record comprises the component number associated with the component and pointers to registry records of components used in its creation;
d. permitting distributors to purchase uses of an entry in the registry and make payment for the uses.

10. The method of claim 9, wherein the computer information system is a computer network.

11. The method of claim 10, wherein the computer network is the Internet.

12. The method of claim 9, wherein the creative works are learning materials.

13. The method of claim 12, wherein the learning materials are to be utilized in developing computer-network based training.

14. The method of claim 9, wherein a transaction log by component that records each use of that component is maintained.

15. The method of claim 9, wherein the original component record in the registry further comprises the original component cost and ownership.

16. The method of claim 9, wherein the new component record in the registry further comprises the new component cost and ownership.
